(19) United States
(12) Patent Application Publication
(10) Pub. No.: US 2021/0180507 A1
(43) Pub. Date: Jun. 17, 2021

(54) SIMULTANEOUS COMBINED-CYCLE MULTI-STAGE COMBUSTION ENGINE

(71) Applicant: Richard Caldwell, Omaha, NE (US)

(72) Inventor: Richard Caldwell, Omaha, NE (US)

(21) Appl. No.: 16/758,918

(22) PCT Filed: Oct. 26, 2018
(86) PCT No.: PCT/US2018/057629

§ 371 Date: Apr. 24, 2020

Related U.S. Application Data
(60) Provisional application No. 62/577,343, filed on Oct. 26, 2017.

(51) Int. Cl. F02B 3/06; F02B 75/00

(52) U.S. Cl. CPC F02B 3/06; F02B 33/22; F02B 75/002

(57) ABSTRACT

A multi-stage combustion engine includes: a pre-compression cylinder including a pre-compression piston operating therein; a combustion cylinder including a combustion piston operating therein. An operating rate of the pre-compression piston is less than an operating rate of the combustion piston.

### CROSS-REFERENCE TO RELATED APPLICATION

This application claims priority to and is a non-provisional of U.S. Patent Application Ser. No. 62/557,343 for a “Simultaneous-combined-cycle Single-valve piston engine” filed on Oct. 26, 2017, the contents of which are incorporated herein by reference in its entirety.

### FIELD AND BACKGROUND

This disclosure relates to the field of combustion engines. More particularly, this disclosure relates to a multi-stage combustion engine that provides improved efficiency.

Internal combustion engines are common and have a wide range of applications. Internal combustion engines have long been in existence and may be provided in various configurations. While efficiency of internal combustion engines has improved, further improvement is desired given rising gas prices and need for reduction in greenhouse gases.

What is needed, therefore, is an improved multi-stage combustion engine that provides improved efficiency and reduced emissions.

### SUMMARY

The above and other needs are met by a multi-stage combustion engine. In a first aspect, a multi-stage combustion engine includes: a pre-compression cylinder including a pre-compression piston operating therein; a combustion cylinder including a combustion piston operating therein. An operating rate of the pre-compression piston is less than an operating rate of the combustion piston.

In one embodiment, the operating rate of the pre-compression cylinder is approximately one-half of the operating rate of the combustion piston. In another embodiment, the pre-compression cylinder and combustion cylinder are oriented in an inverted “V” relationship relative to one another.

In yet another embodiment, the multi-stage combustion engine further includes a re-expansion cylinder including a re-expansion piston operating therein. In one embodiment, an operating rate of the re-expansion cylinder is approximately one-half of the operating rate of the combustion piston. In another embodiment, the pre-compression cylinder, combustion cylinder, and re-expansion cylinder are oriented in an inverted double “V” relationship relative to one another.

In one embodiment, the multi-stage combustion engine further includes an I/O valve in communication with at least one of the pre-compression cylinder and combustion cylinder, the I/O valve including a poppet valve and rotating gate for controlling flow of gases into at least one of the pre-compression cylinder and combustion cylinder.

In another embodiment, the multi-stage combustion engine further includes a shoulder formed around a portion of the re-expansion cylinder for protecting surfaces of the re-expansion cylinder from hot exhaust gases.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a bottom end of a multi-stage combustion engine according to one embodiment of the present disclosure;

FIG. 2 shows a side view of a top end of a combustion cylinder according to one embodiment of the present disclosure;

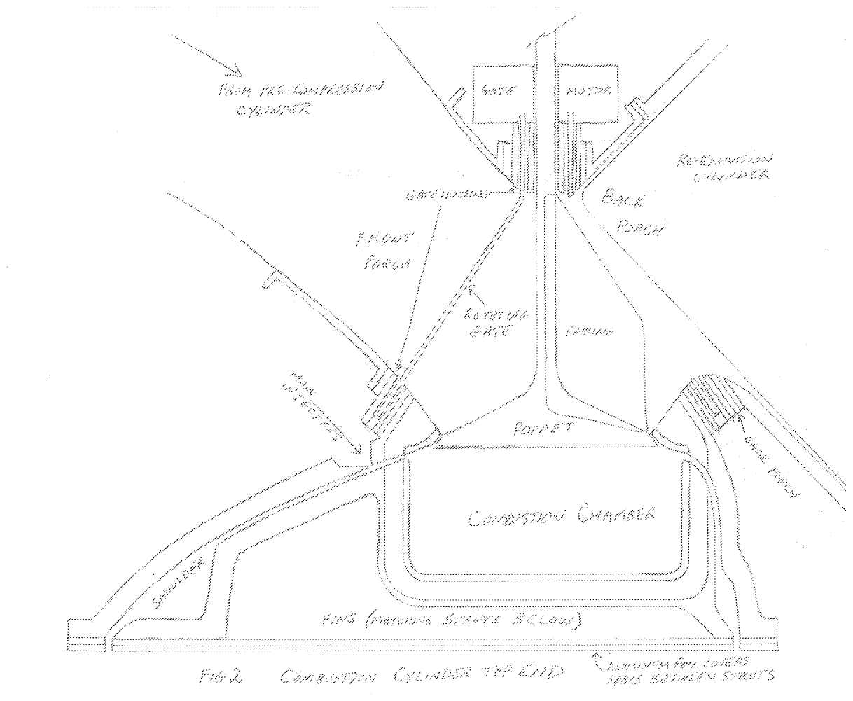

FIG. 3 shows a top view of a combustion cylinder according to one embodiment of the present disclosure;

FIG. 4 shows a side view of a re-expansion cylinder of a multi-stage combustion engine according to one embodiment of the present disclosure;

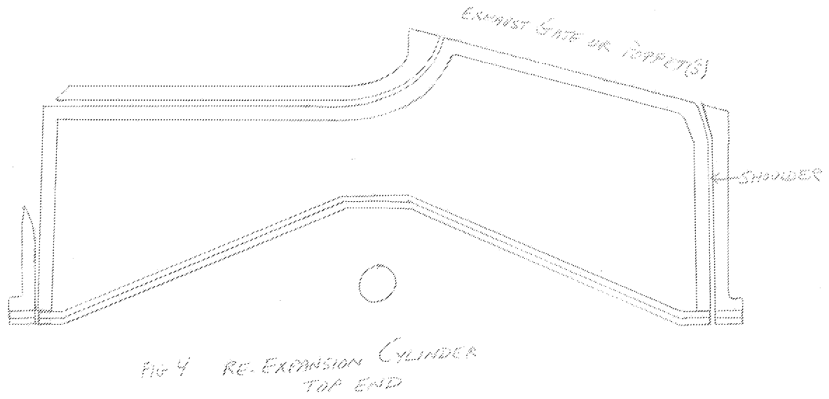

FIG. 5 shows a cross-sectional side view of a top end of a pre-compression cylinder according to one embodiment of the present disclosure;

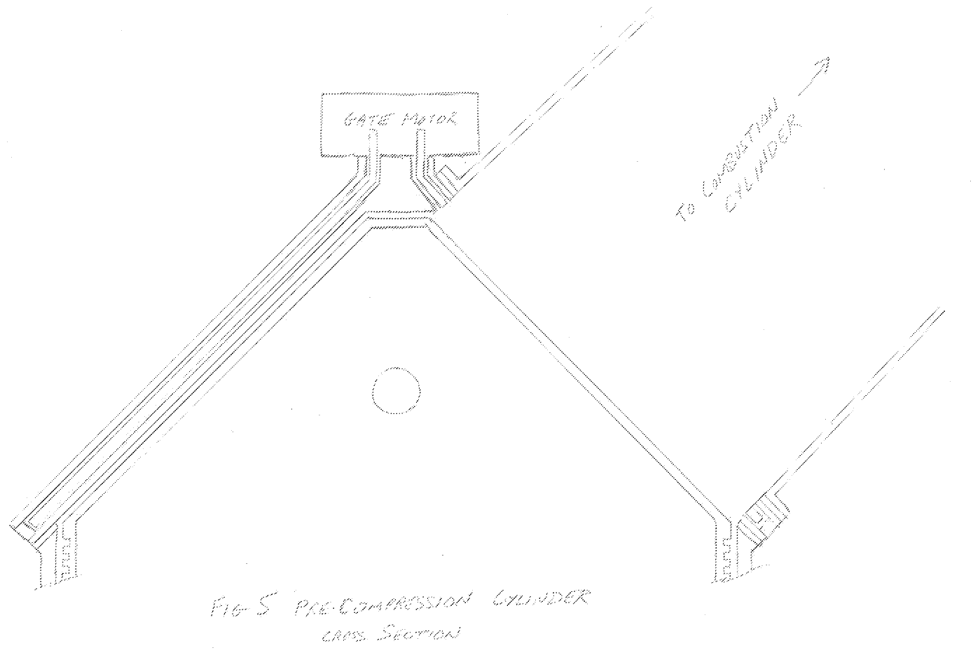

FIG. 6 shows a cross-sectional view of an I/O valve according to one embodiment of the present disclosure; and

FIG. 7 shows a cross-sectional view of a pre-compression cylinder I/O/N gate according to one embodiment of the present disclosure.

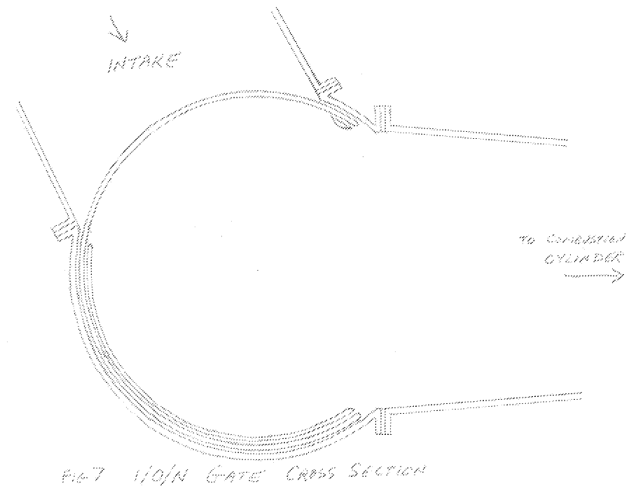

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Embodiments of the present disclosure include an engine having three sequential cylinders in an upside-down double-V configuration. Cylinders preferably include an approximately 225 cc (doesn't need to be metal; perhaps carbon fiber or nylon and Teflon) pre-compression cylinder (PC), an approximately 100 cc 12:1 compression ratio combustion cylinder (CC), and an approximately 600 cc re-expansion cylinder (RC). A total compression ratio of the engine is variable from about 8:1 to 26:1 without affecting the timing or pattern of air entering the CC. The total expansion ratio is 72:1. All of the above dimensions are exemplary, and embodiments of the engine may include varying dimensions and ratios depending on an application of the engine.

The engine is generally constructed of five primary materials: aluminum, low-temperature high thermal expansion steel or iron, high-temperature low thermal expansion steel, forsterite (a high temperature insulation that has a thermal expansion coefficient between steel and titanium), and titanium. This combination of materials allows for various regions of the engine to be run at different temperatures while all of the components maintain similar expansions, from a cylinder wall's oil temperature to the combustion chamber's heat. Coatings can be used for insulation and durability in a steamy environment (both sides of the I/O valve's poppet and rotating gate are good candidates for an insulating coating).

The PC and RC preferably operate at half the CC's RPM so that the PC and RC complete two-stroke cycles during a four-stroke cycle of the CC, as discussed in greater detail below. The PC has a rotating bottomless conical Input/Output/Null gate. The PC's cone-topped piston face fits closely into the gate at TDC. Conical gates function like sleeve valves except that they choose between ports instead of blocking or opening a single port.

The CC and RC have high-temperature steel piston toppers that extend up into their heads. The piston toppers are insulated from the pistons, generally with gasket material that has a low-temperature steel core. Where a topper does not touch its piston head a thin aluminum sheet provides insulation.

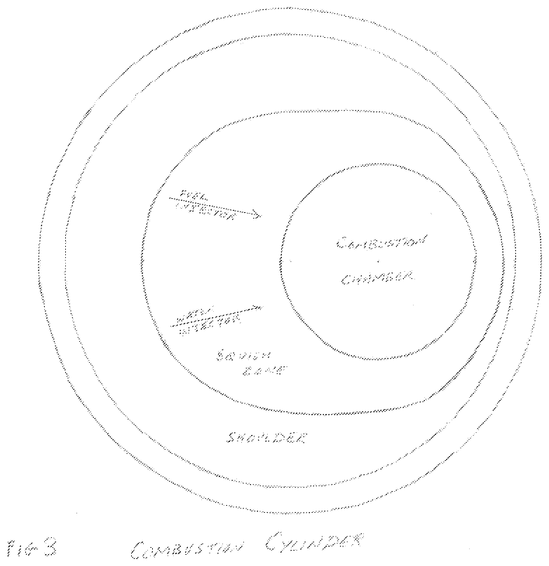

Referring to FIG. 3, at TDC the CC's volume is split between a deep combustion chamber, which is set on the edge of the CC opposite from an input pipe, and the shoulder, which is formed around a perimeter of the cylinder. A squish zone separates the combustion chamber and the shoulder.

The combustion chamber has three layers. An outer layer is high-temperature steel and is a part of the topper. A middle layer is forsterite to provide insulation. An inner layer is titanium. The forsterite and steel layers can be discontinuous for weight reduction.

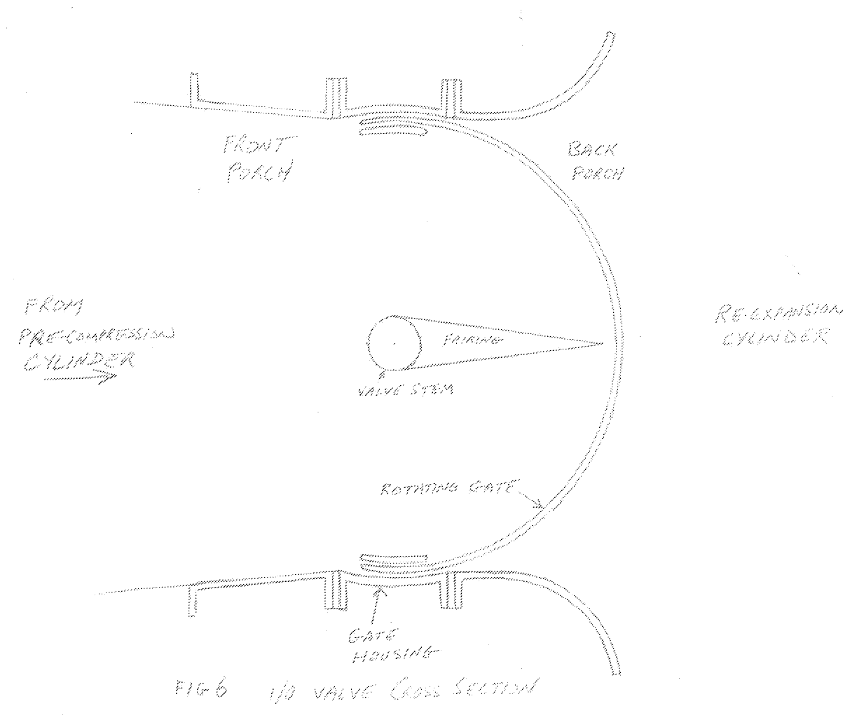

Referring to FIG. 6, the CC has an I/O valve, which includes a titanium poppet valve and a low temperature steel rotating conical gate. The poppet valve stem can have a forsterite fairing to help smooth airflow. The poppet valve opens and closes near BDC, so its slowness is not an issue. Rotating gates are very fast. This means that the CC's exhaust to intake interface can essentially be a square wave (the engine does not use intake air to purge the exhaust).

The RC's exhaust valve is either one or more poppets or a swinging or sliding gate. The RC's exhaust timing depends on the size of the next charge because the RC re-compresses its residual gas to equal or exceed the CC's pressure when the CC's poppet opens.

The RC can exhaust to a water heater, a fuel heater, and/or an oil heater/cooler. The heaters can be coated with various narrow-thermal-range catalysts. Warm water misters can be placed between components to ensure each component operates at its optimal temperature. A turbo-compounder can be used to increase the pressure in the heaters. A final mister can condense the steam and rain out residual pollution. A heat exchanger can cool the water. The water can be filtered and reused.

Generally, all three cylinders use offset pistons. The PC and RC benefit from gravity offsetting lateral piston rod forces. The CC benefits from later fuel and water injection, greater power, torque, and efficiency, and an improved burn with less NOX, as described below.

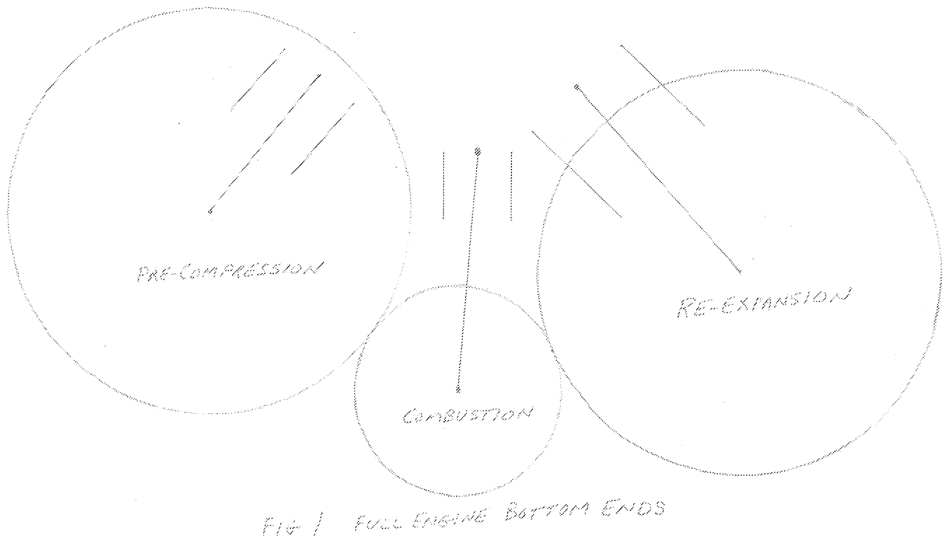

The PC, CC, and RC may be linked with one or more gears, as shown in FIG. 1. Sizes of the gears may vary such that a desirable operating rate of the PC and RC relative to the CC is achieved. While FIG. 1 shows gears, it is also understood that belts or other mechanical components may interconnect the PC, CC, and RC.

The table below shows functions of each of the PC, I/O Valve, CC, and RC during each stroke:

| Stroke | PC | I/O Valve | CC | RC |
|---|---|---|---|---|
| 1 | Intake | X) | Compression | Exhaust |
| 2 | Intake/Spring | X)(X | Power | Exhaust/ |
| | | | | Repressurize |
| 3 | Spring/Compression | (◯ | Output | Input and |
| | | | | Power |
| 4 | Compression/Output | ◯) | Input | Power |

The following occur within a cycle of embodiments of the engine described herein: the PC is near TDC and its gate is at output; the CC is near BDC and its gate is at intake. The CC's poppet is open; the RC is near BDC—its exhaust gate (or poppet) is closed.

### Stroke 1

The PC's gate swings to intake.

The CC's poppet closes.

The RC's exhaust gate (or poppet) opens.

The PC undergoes the first half of its intake stroke. When a desired amount of air is ingested the PC's gate swings to null and the PC functions like an air spring.

The CC begins compression.

The CC injects ambient-to-700F (depending on availability and injector and supply system heat and pressure tolerances) water to extend ignition delay and slow the initial burn. The CC also injects fuel into the combustion chamber so as to simultaneously hit the same places as the water (adjustments, interruptions, and spray patterns will be situation and engine specific). The water adds weight and flings the evolving fuel cloud throughout the combustion chamber. The mixture is extremely rich because the air in the shoulder doesn't get refueled.

The initial burn is very fast and there is essentially little to no NOX. The shoulder's fresh air protects the rings by absorbing shock. The initial burn forces some of the combustion chamber's contents into the shoulder, where it undergoes an extremely lean head start on the second stage of combustion. The CC's offset piston provides extended dwell before TDC, which gives this first stage of combustion plenty of time to complete.

The RC undergoes the first half of its exhaust stroke.

### Stroke 2

The PC is mid-stroke and descending.

The CC is near TDC.

The RC is mid-stroke and ascending.

If still ingesting air, then the PC undergoes the second half of its intake stroke and when the desired amount of air has been ingested the PC's gate swings to null and the PC functions like an air spring.

The CC undergoes its power stroke. The shoulder adds its air for a lean second stage of combustion. The offset piston's minimal dwell after TDC makes for a fast jump past the range where NOX is primarily produced.

The RC undergoes the second half of its exhaust stroke.

The RC's exhaust closes and the CC's gate swings to output as the RC approaches TDC. The RC undergoes a small compression that increases the pressures in the RC, the back porch, and the I/O valve so as to equal or exceed the CC's pressure near BDC, which is when the CC's poppet opens.

### Stroke 3

The PC is near BDC.

The CC is near BDC.

The RC is near TDC.

The PC begins its compression partial-stroke. When the PC's pressure equals or exceeds the transfer pipe's pressure the PC's gate swings to output. This joins the PC, the transfer pipe, and the front porch, which together function like an air spring. The PC continues its compression partial-stroke.

The CC undergoes its output stroke, which mixes in the I/O valve's air, which results in a very lean third stage. If needed, one or more low-pressure warm water injectors purge some or all of the exhaust gas while cooling the combustion chamber, the back of the poppet, the shoulder, and the upper cylinder wall. This steam adds power to the re-expansion process and weight to the next charge (since the PC to CC transfer is positive displacement neither exhaust gas nor steam affect volumetric efficiency).

The RC undergoes the first half of its power stroke.

### Stroke 4

The PC is mid stroke and ascending.

The CC is near TDC.

The RC is mid stroke and descending.

If not already there, the PC's gate swings to output. The CC's gate swings to intake. The CC's poppet stays open.

The PC/transfer pipe/front porch combination undergoes output.

The CC undergoes input. The CC's poppet's placement on the edge of the cylinder splits the input stream to the sides so as to initiate a pair of counter-rotating swirls. The intake's angle and placement initiates tumble. The ledge between the poppet's opening and the rotating gate provides turbulence.

The RC undergoes the second half of its power stroke.

Slow air handling makes for low friction, pumping, compression, and expansion losses. Equivalent CC strokes used for:

Intake: Variable, 0.6 to 2 strokes through a large gate (more torque=longer intake)

Compression: Variable, 1 to 2.6 strokes (more torque=longer compression)

Expansion/Power: Three strokes

Exhaust: Almost two strokes through a large gate.

No throttle, no turbo, no EGR, no Atkinson/Miller, no spark, always super-choked so initial start can simply use a higher compression ratio and/or less or no water, no 3-way cat, a silicone, other non-metallic, or no muffler, no flywheel (counter-rotating gears handle the function), low octane, and essentially no non-CO2 emissions (the 3-stage burn starts with a fast ultra-rich and steamy initial burn, then leaps to a to too lean and steamy for significant NO second stage in the CC. The RC adds an extended extra-lean, cool, and steamy third stage, which drives NO to NO2 and burns NO2, HC, CO, and soot; after that: NO2 and CO are rained out and re-burned via subsequent water injection, HC is catalytically oxidized in the heaters and soot is rained out and filtered). The CC's and RC's shoulders protect their cylinder walls from heat and the CC's rings from shock and the CC's bottom end from hydrocarbons. They also make oil skimming benign.

The PC can shove in the correct amount of air for ignition regardless of engine temperature, so no warm-up spark is needed, and the shoulder's shock absorbing capacity combined with the power spreading provided by the steam cycle and 3-stage combustion allows for an extremely fast initial burn.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A multi-stage combustion engine comprising:
a pre-compression cylinder including a pre-compression piston operating therein;
a combustion cylinder including a combustion piston operating therein;
wherein an operating rate of the pre-compression piston is less than an operating rate of the combustion piston.

2. The multi-stage combustion engine of claim 1, wherein the operating rate of the pre-compression cylinder is approximately one-half of the operating rate of the combustion piston.

3. The multi-stage combustion engine of claim 1, wherein the pre-compression cylinder and combustion cylinder are oriented in an inverted “V” relationship relative to one another.

4. The multi-stage combustion engine of claim 1, further comprising a re-expansion cylinder including a re-expansion piston operating therein.

5. The multi-stage combustion engine of claim 4, wherein an operating rate of the re-expansion cylinder is approximately one-half of the operating rate of the combustion piston.

6. The multi-stage combustion engine of claim 4, wherein the pre-compression cylinder, combustion cylinder, and re-expansion cylinder are oriented in an inverted double “V” relationship relative to one another.

7. The multi-stage combustion engine of claim 1, further comprising an I/O valve in communication with at least one of the pre-compression cylinder and combustion cylinder, the I/O valve including a poppet valve and rotating gate for controlling flow of gases into at least one of the pre-compression cylinder and combustion cylinder.

8. The multi-stage combustion engine of claim 4 further comprising a shoulder formed around a portion of the re-expansion cylinder for protecting surfaces of the re-expansion cylinder from hot exhaust gases.
